(19) United States
(12) Patent Application Publication
(10) Pub. No.: US 2004/0257397 A1
(43) Pub. Date: Dec. 23, 2004

(54) Spittoon mechanism and method

(76) Inventors: Antonio Gomez, Vancouver, WA (US); John A. Barinaga, Portland, OR (US); Russell P. Yearout, Brush Prairie, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/600,663

(22) Filed: Jun. 20, 2003

(51) Int. Cl. B41J 2/165

(52) U.S. Cl. 347/35

(57) ABSTRACT

A spittoon system is provided for a printing mechanism having a printhead with a substantially linear nozzle array oriented in a first direction. The spittoon system includes a frame and a roller mounted to the frame for rotation about an axis oriented in the first direction to receive ink spit from the printhead.

### BACKGROUND

Printing mechanisms, such as those used in desktop printers, may use one or more print cartridges, sometimes referred to as “pens” which may shoot drops of liquid colorant, referred to generally herein as “ink,” onto print media, such as paper. Each print cartridge may have a printhead with very small nozzles through which the ink drops are fired using various technologies, such as thermal or piezo-electric inkjet technology. Between incremental advancing steps of the media through a printzone, the printhead may be propelled back and forth across the media while selectively firing drops of ink on the media to form a desired image. The printhead nozzles may be arranged in linear arrays, oriented perpendicular to a scanning axis of the printheads. To maintain printhead health, the printheads may be serviced in a service station area of the printing mechanism wherein the servicing routine may include purging ink blockages from the nozzles into a spittoon during an operation known as “spitting.”

A variety of different spittoon designs have been proposed but suffer from the problems of ink stalagmite formation and ink aerosol generation. Therefore, for these and other reasons there is a need for the present invention

### SUMMARY

One embodiment of a spittoon system is provided for a printing mechanism having a printhead with a substantially linear nozzle array oriented in a first direction. The spittoon system includes a frame and a roller mounted to the frame for rotation about an axis oriented in the first direction to receive ink spit from the printhead.

### BRIEF DESCRIPTION OF THE DRAWINGS

FIG. 1 is a partially schematic, fragmented, perspective view of one embodiment of a printing mechanism, including a roller spittoon for servicing printheads according to an embodiment of the present invention.

FIG. 2 is a perspective view of one embodiment of the printheads shown in a servicing position over the spittoon of FIG. 1.

FIG. 3 is a bottom plan view of one embodiment of a nozzle arrangement for the printheads shown in FIG. 2, with the individual nozzles shown greatly enlarged for purposes of illustration.

FIG. 4 is a perspective view of the spittoon of FIG. 1.

FIG. 5 is a perspective view of one embodiment of a group of moving components of the spittoon of FIG. 1.

FIG. 6 is a perspective view of one embodiment of a group of spit rollers and scrapers of the spittoon of FIG. 1.

FIG. 7 is a front elevational, sectional view of the spittoon of FIG. 4, taken along lines 7-7 thereof, with the drive motor omitted for clarity.

### DETAILED DESCRIPTION OF THE DRAWINGS

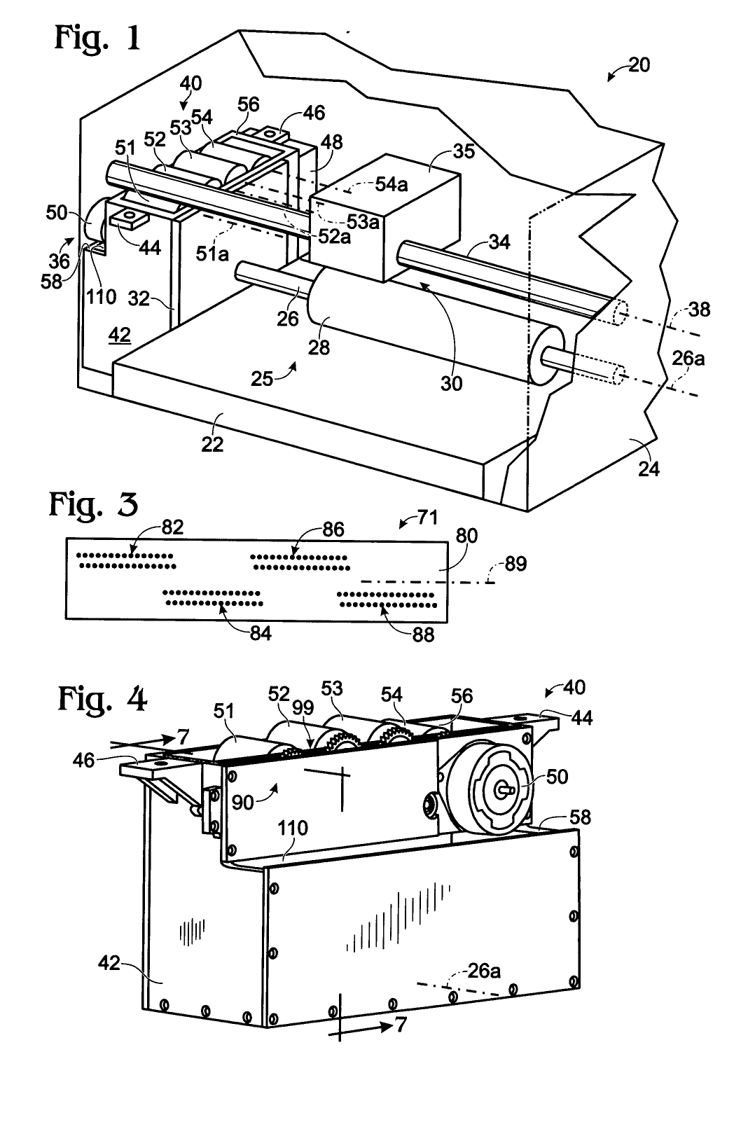

FIG. 1 illustrates one embodiment of a printing mechanism, here shown as a printer 20, which may include a base chassis 22, and an exterior housing 24. A media handling system 25 may include a drive roller shaft 26 which may include a series of media drive rollers or a single drum 28, which may propel media through a printzone 30 in incremental advances during printing. The drive roller shaft 26 may be rotatably supported by printer chassis 22, for example as shown at support 32. The chassis 22 may fixedly support a carriage guide rod 34 along which a printhead carriage 35 may traverse through printzone 30 and into a servicing zone 36 along a scanning axis 38, which may be defined by guide rod 34. The printing mechanism 20 of the present embodiment may be utilized for printing business reports, correspondence, advertising materials, product packaging, desktop publishing, and the like, in an office, home or other environment. A variety of printers are commercially available. For instance, some of the printers that may include embodiments of the present invention include plotters, portable printing units, copiers, cameras, video printers, and facsimile machines, to name a few.

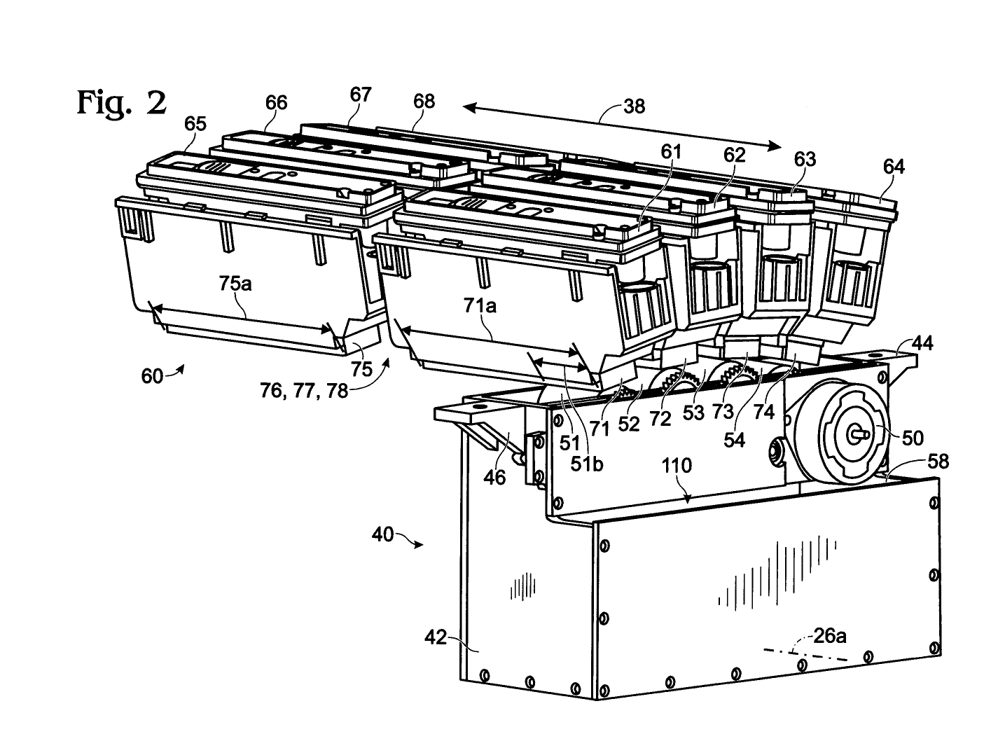

A roller spittoon 40 may be housed within the servicing zone 36, and may include a frame 42 which may be supported by a portion of chassis 22, for instance at attachment mounting tabs 44 and 46, as illustrated by the engagement of tab 46 with support 48 (the support structure at tab 44 has been omitted for clarity). A drive motor 50 may be supported by frame 42 to engage and drive a group of spit rollers, such as rollers 51, 52, 53 and 54, which may be rotatably supported by frame 42 within an upper portion 56 of frame 42 which lies above a lower portion 58 of frame 42. Rollers 51, 52, 53 and 54 may each be mounted on frame 42 for rotation about an axis 51a, 52a, 53a and 54a, respectively, wherein axes 51a-54a may be positioned parallel to scanning axis 38. The outer cylindrical surface of spit rollers 51-54 may define a target surface for receiving ink spit from the printheads (see FIG. 2) during the spitting routine. Rollers 51-54 may be positioned in an arcuate configuration having a radial midpoint aligned with a rotational axis 26a of drive roller shaft 26.

FIG. 2 shows an embodiment of a fast throughput printhead assembly 60, which may be transported by carriage 35 (see FIG. 1) between printzone 30 (see FIG. 1) and servicing zone 36 (see FIG. 1). The illustrated printhead assembly 60 may include eight inkjet cartridges 61-68 which may carry printheads 71-78, respectively. Printheads 76-78, not visible in this view, may be positioned on a lower surface of inkjet cartridges 66-68, respectively, and in a similar orientation as is printhead 75 on the lower surface of inkjet cartridge 65. In the illustrated embodiment, printheads 71 and 75 may deposit ink on spit roller 51, printheads 72 and 76 may deposit ink on roller 52, printheads 73 and 77 may deposit ink on roller 53, and printheads 74 and 78 may deposit ink on roller 54. In an embodiment including a page wide printing array, one or more printheads may extend across the full width of printzone 30, as measured parallel to rotational axis 26a of drive roller shaft 26.

FIG. 3 shows one embodiment of a nozzle arrangement suitable for printhead 71, which nozzle arrangement may also be used for printheads 72-78. Printhead 71 may include a nozzle plate 80, which may be positioned on a lower surface of printhead 71, and which may define four pairs of linear nozzle arrays 82, 84, 86 and 88. The illustrated printheads 71-78 (see FIG. 2) may each have their nozzle arrays 82-88 aligned along an axis 89 parallel to scanning axis 38 (see FIG. 1) and spit roller axes 51a-54a (see FIG. 1). Note that the individual nozzles in each linear array 82-88 are shown greatly enlarged for purposes of illustration.

In the illustrated embodiment, with the nozzle linear arrays 82-88 oriented parallel to scanning axis 38, groups of nozzles may be spit as the printheads 71-78 (see FIG. 2) traverse over rollers 51-54 (see FIG. 1), rather than spitting all of the printhead's nozzles at a single time. With the nozzle linear arrays 82-88 oriented in a same direction as the axis of rotation of the rollers 51-54, the nozzles of individual linear arrays are all positioned at a substantially same vertical distance from a round surface of an associated roller. This configuration may permit spitting from nozzles of a linear array simultaneously at a substantially constant vertical distance from an associated roller. By creating a substantially uniform distance between individual nozzles of an array of nozzles and the surface of an associated roller, the roller and the nozzles may be positioned close to each other to reduce aerosol generation. If, however, the linear array of nozzles were oriented otherwise, individual nozzles of the array would be located at different vertical distances from the roller surface due to the curvature of the roller surface, thereby resulting in uneven spit distances between the individual nozzles and the roller surface, which may result in undesirable aerosol generation.

The design shown also enables spitting under motion, also known as “spitting on-the-fly,” which speeds the spitting routine. Furthermore, the illustrated embodiment of roller spittoon system 40 (see FIG. 1) having rollers 51-54 with spit target surfaces which are more narrow than the length of their associated printheads yields a more compact service station design having a narrower width, which again reduces size of the footprint of inkjet printing mechanism 20. In other words, referring to FIG. 2, a length 51b of spit roller 51 may be less than a length 71a and 75a of corresponding printheads 71 and 75. Similarly, rollers 52-54 may each have a length less than a length of their corresponding printheads. In some implementations where reducing footprint size is not a concern, the spit rollers may have a length equal to or greater than that of the array of nozzles of the associated printhead, or for a printhead arrangement similar to that of printhead assembly 60, the length of the roller may extend to accommodate multiple printheads. In some embodiments, all of the printheads 71-78 are not coplanar, but rather may be arranged in an arcuate fashion (see FIG. 2) centered on axis 26a of shaft 26, which may correspond to an arcuate printzone path as the print media passes over drum 28 (see FIG. 1). In the illustrated embodiment, the first group of printheads 71-74 may enter the servicing zone 36 arranged in an arcuate configuration with respect to one another. The second group of printheads 75-78 may also enter the servicing zone arranged in an arcuate configuration with respect to one another. In order to quickly capture floating ink aerosol satellites generated during a spitting routine, spit rollers 51-54 may be arranged in a similar arcuate relationship (see FIG. 2) to maintain a close printhead to spit target surface spacing 87 (see FIG. 7). Also in the illustrated embodiment, printheads 71 and 75 may be coplanar, printheads 72 and 76 may be coplanar, printheads 73 and 77 may be coplanar, and printheads 74 and 78 may be coplanar. It is apparent that other orientations of the printheads 71-78 may be more suitable in some implementations, and may lead to other arrangements of the spit rollers to maintain a close printhead to spit target surface relationship in an effort to capture floating ink aerosol satellites.

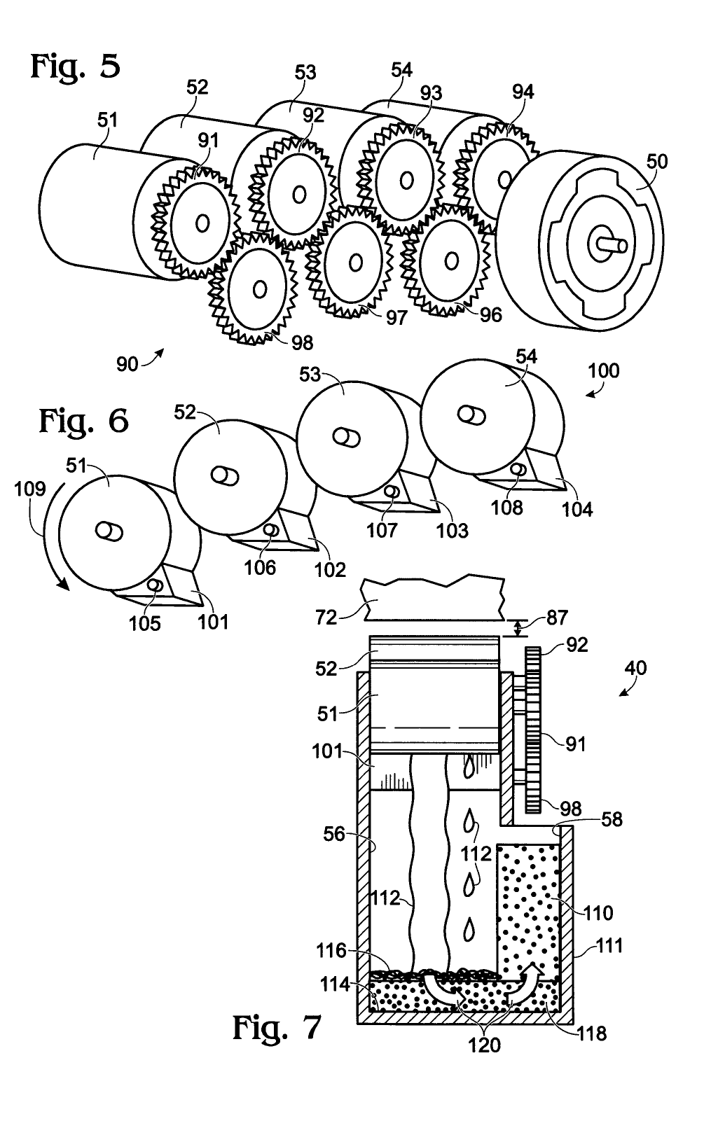

FIGS. 4 and 5 illustrate the location and construction of one embodiment of a roller spittoon drive assembly, here, shown as gear train assembly 90, which may be used to couple motor 50 to drive each of rollers 51-54. As best shown in FIG. 5, gear train assembly 90 may include drive gears 91, 92, 93 and 94 directly coupled to support shafts of spit rollers 51, 52, 53 and 54, respectively. To transfer the drive power from motor 50 and gear 94 to the remaining gears 91-93, three idler gears 96, 97 and 98 may be provided. As is apparent from viewing FIG. 5, the drive force from gear 94 may propel idler gear 96, which in turn may propel gear 93, which in turn may propel idler gear 97, which in turn may propel gear 92, which in turn may propel idler gear 98, which finally in turn propels gear 91.

Although each of the drive gears 91-93, and each of the idler gears 96-98, are shown in the illustrated embodiment to be identical with gear 94, for inventory economy and the convenience of manufacturing assembly, it should be noted that any gear arrangement may be utilized. Indeed, a variety of other drive mechanisms may be used to transfer rotational power from drive motor 50 to spit rollers 51-54, including drive belts or drive chains (not shown), and the like, and including separate dedicated motors (not shown) for each spit roller. In some implementations, other gear or drive tooth combinations may be employed, for instance if some spit rollers require rotation more frequently than others to handle a different type of ink residue spit from printhead pairs 71 and 75, 72 and 76, 73 and 77, or 74 and 78. Other embodiments for accomplishing different rotational speeds for spit rollers 51-54 may also be employed, for example by constructing the rollers with different diameters.

Referring to FIG. 4, in the illustrated embodiment gear train assembly 90 may be housed within a separate optional gear chamber 99, defined by spittoon frame 42. Use of separate gear chamber 99 may assist in providing mechanical support for rollers 51-54, and may provide some isolation for sheltering gears 91-98 (see FIG. 5) from ink residue generated during a spitting routine. While gear chamber 99 is shown as being an open enclosure in the illustrated embodiment, in other implementations it may be desirable to enclose the gear chamber to minimize contamination from ink aerosol or other ink residue. As mentioned above, chamber 99 may house other drive mechanisms to transfer rotational force from motor 50 to spit rollers 51-54.

FIG. 6 shows one embodiment of a scraper assembly 100, used to remove ink residue from the outer cylindrical target surface of spit rollers 51-54. In the illustrated embodiment, scraper assembly 100 includes scrapers 101, 102, 103 and 104 which may be used to remove ink residue from spit rollers 51, 52, 53 and 54, respectively. Scrapers 101, 102, 103 and 104 may be fixedly mounted to spittoon frame 42 (see FIG. 4) at points 105, 106, 107 and 108, respectively. In this orientation, as spit rollers 51-54 each rotate in a counterclockwise direction 109 scrapers 101-104 may remove ink residue from the surface of the rollers, as best shown in FIG. 7.

Other printhead servicing members may be located within the servicing zone 36 (see FIG. 1), such as: caps (not shown) for sealing the printheads during periods of inactivity, wipers (not shown) for cleaning the nozzle orifice plates of the printheads, wiper cleaning devices (not shown), ink solvent dispensers (not shown), applicators (not shown) for applying the ink solvent to the printheads, and printhead primers (not shown). The motor or motors used to move these other servicing members into a servicing position may also be linked to drive spit rollers 51-54 to be cleaned by scrapers 101-104 during printing, or while other printhead servicing operations occur, which may speed the overall servicing process.

In FIG. 7 spittoon frame lower portion 58 may define a lower waste bucket 111, which in the illustrated embodiment may be filled with an absorbent liner 110 of a felt, fibrous, sponge-like, or other porous material which may assist in storing liquid ink residue until the volatile or evaporatable components evaporate there from leaving solid ink waste components behind. In this figure, first scraper 101 is shown removing ink residue 112 from spit roller 51. Lower waste bucket 111 may define a bottom surface 114. As ink residue 112 falls away from spit roller 51, it initially may form a pile of ink residue 116. While absorbent liner 110 may extend across the entire width of lower portion 58 of the spittoon frame, in the illustrated embodiment bottom surface 114 is overlaid by a bottom liner 118, which may be of the same or different material than used to construct liner 110. In some implementations, it may be advantageous to select the materials of liners 110 and 118 to have capillary forces which draw liquid components of the collected ink residue 116 first into the bottom liner 118 and then into larger more permanent storage liner 110, as illustrated by arrows 120 in FIG. 7. In other embodiments, bottom liner 118 may be omitted, or may only extend over a portion of spittoon frame bottom surface 114.

Due to the non-coplanar orientation of the illustrated multiple printheads 71-74 and 75-78 (see FIG. 2), in some implementations it may be desirable to use a single spit roller of the same or larger diameter than those illustrated herein, and space the printheads around such a single roller, or perhaps a group of spit rollers. For some implementations it may be satisfactory to space the printheads at a uniform distance from the spit roller(s). In other implementations it may be satisfactory to have a nonuniform spacing between the printheads and their associated spit roller(s), for example to accommodate different ink types.

The illustrated embodiment of FIGS. 1-7 is shown to illustrate the principles and concepts of the invention as set forth in the claims below, and a variety of modifications and variations may be employed in various implementations while still falling within the scope of the claims below.

We claim:

1. A spittoon system for a printing mechanism having a printhead with a substantially linear nozzle array oriented in a first direction, comprising:
a frame; and
a roller mounted to the frame for rotation about an axis oriented in said first direction to receive ink spit from said printhead.

2. A spittoon system according to claim 1 for a printing mechanism having a second printhead, further comprising a second roller mounted to the frame for rotation and about a second axis oriented in said first direction to receive ink spit from said second printhead.

3. A spittoon system according to claim 1 for a printing mechanism having a second printhead, wherein said roller is oriented to receive ink spit from said second printhead.

4. A spittoon system according to claim 1, further comprising a drive motor coupled to rotate said roller.

5. A spittoon system according to claim 4, further comprising a gear train which couples the motor to the roller.

6. A spittoon system according to claim 1, wherein the frame defines a waste ink reservoir located to receive waste ink from said roller.

7. A spittoon system according to claim 6, further comprising a liner of an absorbent material located within said waste ink reservoir.

8. A spittoon system according to claim 1 for a printing mechanism having second, third, and forth printheads, further comprising:
a second roller mounted to the frame for rotation and about a second axis oriented in said first direction to receive ink spit from said second printhead;
a third roller mounted to the frame for rotation and about a third axis oriented in said first direction to receive ink spit from said third printhead; and
a fourth roller mounted to the frame for rotation and about a fourth axis oriented in said first direction to receive ink spit from said fourth printhead.

9. A spittoon system according to claim 8, further comprising:
a drive motor;
a gear train which couples the motor to said roller, said second roller, said third roller, and said fourth roller;
wherein the frame defines a waste ink reservoir located to receive waste ink from said roller, said second roller, said third roller, and said fourth roller;
plural scrapers mounted to said frame to engage said rollers and remove waste ink therefrom; and
a liner of an absorbent material located within said waste ink reservoir.

10. A method of purging waste ink from a printhead of a printing mechanism having printheads for dispensing ink, comprising:
positioning at least some of said printheads over rollers; and
purging waste ink from said printheads onto the said rollers.

11. A method according to claim 10 wherein said printheads have nozzles which dispense said ink, and said positioning comprises positioning said rollers a substantially uniform distance from said nozzles.

12. A method according to claim 10 wherein said printheads form a first contour and said positioning comprises positioning said rollers in a second contour similar to the first contour.

13. A method according to claim 12 wherein said first contour comprises an arcuate shape, and said second contour comprises an arcuate shape.

14. A method according to claim 12 wherein said first contour comprises a semicircular shape, and said second contour comprises a semicircular shape.

15. A spittoon system for a printing mechanism having a printhead with a substantially linear nozzle array oriented in a first direction, comprising:
means for receiving ink spit from said printhead; and
means for rotating said means for receiving ink about an axis oriented in said first direction.

16. A spittoon system according to claim 15 wherein said printing mechanism has a second printhead with a substantially linear nozzle array oriented in said first direction, and further comprising:
means for receiving ink spit from said second printhead; and
means for rotating said means for receiving ink spit from said second printhead about a second axis oriented in said first direction, said second axis distinct from said axis.

17. A spittoon system according to claim 15 further comprising means for storing waste ink.

18. A spittoon system according to claim 15 further comprising means for scraping waste ink from said means for receiving ink.

19. A spittoon system according to claim 15 further comprising:
means for scraping waste ink from said means for receiving ink;
means for storing waste ink;
means for absorbing waste ink in said means for storing; and
wherein said means for rotating comprises a motor and means for transferring rotational motion from said motor to said means for receiving ink.

20. A printing mechanism, comprising:
a chassis defining a printzone and a servicing zone;
a printhead having a substantially linear nozzle array oriented in a first direction;
a carriage which moves the printhead through the printzone and the servicing zone;
a frame located in the servicing zone; and
a roller mounted to the frame for rotation about an axis oriented in said first direction and located to receive ink spit from said printhead.
